(19) United States
(12) Patent Application Publication
(10) Pub. No.: US 2007/0121355 A1
(43) Pub. Date: May 31, 2007

(54) CMOS full wave rectifier

(76) Inventor: Clemens M. Zierhofer, Kundl (AT)

Correspondence Address: BROMBERG & SUNSTEIN LLP, 125 SUMMER STREET, BOSTON, MA, 02110-1618, US

(21) Appl. No.: 11/482,547

(22) Filed: Jul. 7, 2006

Related U.S. Application Data
(60) Provisional application No. 60/697,624, filed on Jul. 8, 2005.

(51) Int. Cl. H02M 7/00

(52) U.S. Cl. 363/125

(57) ABSTRACT

A rectifier circuit includes first and second input terminals for receiving a rectangular wave input voltage, and first and second output terminals for providing a rectified dc output voltage. A first switch is coupled between the first input terminal and a first node, the first node being coupled to the first output terminal. A second switch is coupled between the second input terminal and the first node. A third switch is coupled between the first input terminal and a second node, the second node being coupled to the second output terminal. A fourth switch is coupled between the second input terminal and to the second node. The first switch and fourth switch are gated on when the input voltage is of a first polarity; and the second switch and the third switch are gated on when the input voltage is of a second polarity opposite the first polarity so as to provide an output voltage having a magnitude substantially equal to the magnitude of the input voltage.

This application claims priority from U.S. Provisional Patent Application 60/697,624, filed Jul. 8, 2005, the contents of which are incorporated herein by reference.

### FIELD OF THE INVENTION

The present invention relates to a rectifier circuit, and more particularly, to a CMOS full-wave rectifier circuit.

### BACKGROUND ART

Generally, rectifiers are used for the conversion of AC to DC voltage. A conventional full-wave rectifier that includes a diode bridge 105 is shown in FIG. 1. The diode bridge 105 can be regarded as a non-linear, two-port device having an input voltage u₁(t), an output voltage u₂(t), and four diodes 101, 102, 103, and 104. In general, the output port is connected to a load 106. If the load 106 is a purely resistive load 107, then the sign of the input voltage u₁(t) defines the current path through the rectifier 105, i.e., whether the current is flowing through diodes 101 and 102, or through diodes 103 and 104. However, the current through load 107 has the same direction in both cases. The resulting voltage u₂(t) is given by:
u₂(t)=|u₁(t)|−2u_{D}, if |u₁(t)|≧2u_{D}, and (1a)
u₂(t)=0, if |u₁(t)|<2u_{D}, (1b)
where u_{D} denotes the voltage drop across one diode. As a general disadvantage, the voltage drop across load 107 is not the full magnitude of the input voltage difference |u₁(t)|, but diminished by 2u_{D}, i.e., by two diode voltage drops (typically, 1.4V). For low power applications, the diode voltages may significantly contribute to the overall power consumption of the circuit.

The diode bridge shown in FIG. 1 is often used for supply voltage generation. In this case the load could be a resistor 108 (representing the power consumption of a complex electronic circuit) and a smoothing capacitor 109 connected in parallel. For a given frequency of the input signal u₁(t), capacitor 109 usually is chosen sufficiently large to ensure a nearly constant supply voltage u₂(t).

### SUMMARY OF THE INVENTION

A rectifier and method for rectification includes a bridge that is advantageously implemented using switches as opposed to diodes. The switches may be, without limitation, MOS transistors. Such a rectifier may be used, for example, in a wide variety of applications, such as medical or automotive applications.

In accordance with an embodiment of the invention there is provided a rectifier circuit which includes first and second input terminals for receiving a rectangular wave input voltage, and first and second output terminals for providing a rectified dc output voltage. A first switch is coupled between the first input terminal and a first node, the first node being coupled to the first output terminal. A second switch is coupled between the second input terminal and the first node. A third switch is coupled between the first input terminal and a second node, the second node being coupled to the second output terminal. A fourth switch is coupled between the second input terminal and to the second node. The first switch and fourth switch are gated on when the input voltage is of a first polarity; and the second switch and the third switch are gated on when the input voltage is of a second polarity opposite the first polarity so as to provide an output voltage having a magnitude substantially equal to the magnitude of the input voltage.

In accordance with related embodiments of the invention, the first switch, the second switch, the third switch, and the fourth switch may be MOS transistors. For example, the first switch and the second switch may be PMOS transistors, and the third switch and fourth switch may be NMOS transistors. The first switch and the fourth switch may be gated by one of the first input terminal and the second input terminal, and the second switch and the third switch may be gated by the other of the one of the first input terminal and the second input terminal. A parallel load combination of a resistance and a capacitance may be coupled to the rectifier circuit between the first and second output terminals. Or a resistive load may be coupled to the rectifier circuit between the first and second output terminals without a discrete parallel capacitor. Both the load and the rectifier circuit may be integrated on a single chip. The circuit may be used to ensure a desired supply voltage polarity.

In accordance with another embodiment of the invention, a polarity protection circuit includes the rectifier circuit of the above-described embodiments. In another embodiment, an implanted medical device, such as a retinal implant or a cochlear implant, includes the rectifier circuit of the above-described embodiments. In accordance with still another embodiment of the invention, a chip includes both the rectifier circuit of the above-described embodiments and a parallel load combination of a resistance and a capacitance coupled between the first and second output terminals. Or the load may be a resistive load without a discrete parallel capacitor. The load may include a signal processor.

In accordance with yet another embodiment of the invention, a method of rectifying is presented. The method includes applying a rectangular input signal between a first input terminal and a second input terminal. A first switch is coupled between the first input terminal and a first node, and a second switch is coupled between the second input terminal and the first node. The first node is coupled to a first output terminal. A third switch is coupled between the first input terminal and a second node, and a fourth switch is coupled between the second input terminal and the second node. The second node is coupled to a second output terminal. The first switch and fourth switch are gated on when the input signal is of a first polarity; while the second switch and the third switch are gated on when the input signal is of a second polarity opposite the first polarity so that the first and second output terminals provide a rectified dc voltage having a magnitude substantially equal to the magnitude of the input voltage.

In accordance with related embodiments of the invention, the first switch, the second switch, the third switch, and the fourth switch may be MOS transistors. The first switch and the second switch may be PMOS transistors, and the third switch and fourth switch may be NMOS transistors. The first switch and the fourth switch may be gated by one of the first input terminal and the second input terminal, and the second switch and the third switch may be gated by the other of the one of the first input terminal and the second input terminal. The method may further comprise coupling a parallel load combination of a resistance and a capacitance between the first and second output terminals. Or the method may further comprise coupling a resistive load between the first and second output terminals without a discrete parallel capacitor. In a further embodiment, the input signal may be disconnected from the input terminals for a period of time after the switches are gated on.

### BRIEF DESCRIPTION OF THE DRAWINGS

FIG. 1 is a schematic showing a full-wave bridge rectifier with varying loads (Prior Art);

FIG. 2 is a schematic showing a CMOS-bridge with varying loads, in accordance with an embodiment of the invention; and

FIG. 3 is a schematic showing a CMOS-bridge for supply voltage generation for square wave input signals, in accordance with an embodiment of the invention.

FIG. 4 shows a rectangular wave input signal having active and floating periods according to one embodiment of the invention.

### DETAILED DESCRIPTION OF SPECIFIC EMBODIMENTS

In illustrative embodiments, a rectifier includes a bridge that is implemented using switches. The switches may be, for example, MOS transistors. Details of illustrative embodiments are discussed below.

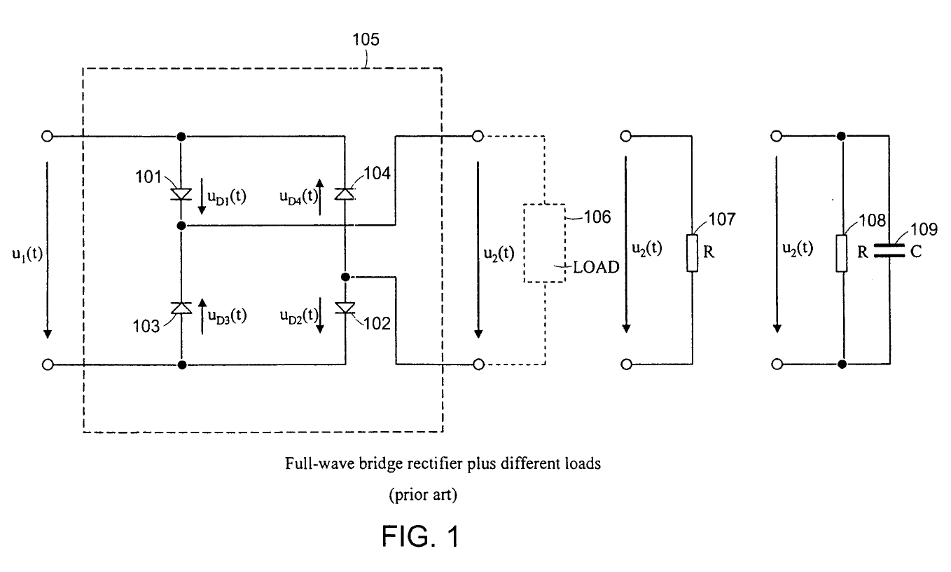

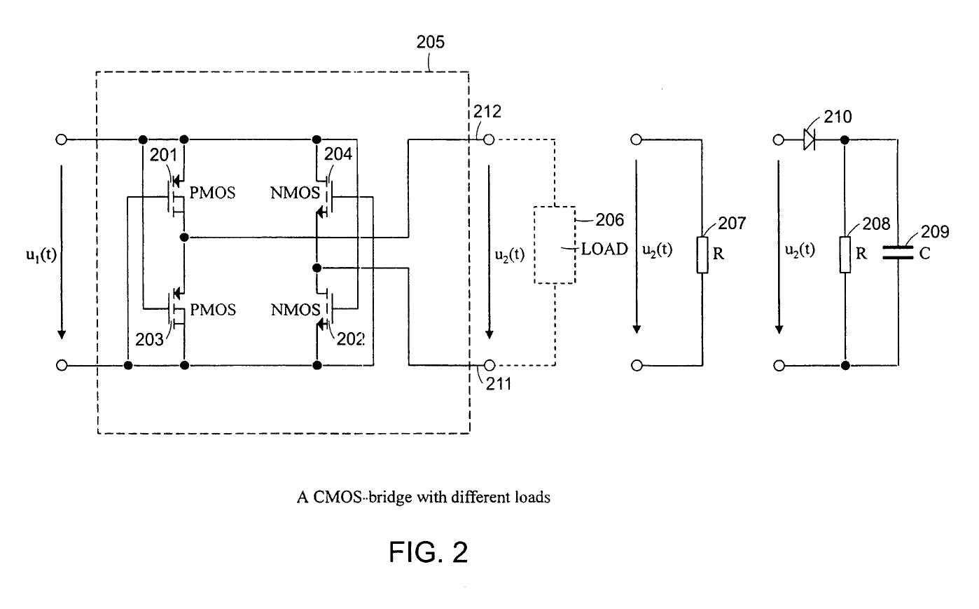

FIG. 2 is a schematic showing a CMOS-bridge with varying loads, in accordance with an exemplary embodiment of the invention. The arrangement of transistors as shown in FIG. 2 represents a non-linear two-port device 205 with input voltage u₁(t) and output voltage u₂(t). As compared to the diode bridge of FIG. 1, the four diodes are replaced by four transistors, i.e., by two PMOS-transistors 201 and 203, and two NMOS transistors 202 and 204, which are operated as ON/OFF-switches. It is to be understood that in various embodiments the MOS transistors may be replaced by other types of switching technologies which may be, for example, electrical, mechanical, biological or molecular in nature, and that the present invention is not limited to MOS technology.

As shown in FIG. 2 the output terminals 211 and 212 of the two-port device 205 may be connected to a load 206. The load 206 may be, for example, a resistive load 207, or a resistive load 208 in parallel with a capacitive load 209. Both the two-port device 205 and the load 206 may be advantageously integrated on single chip. For example, the two-port device 205 may be electrically coupled with other circuitry, such as a signal processor, the two-port device 205 and signal processing circuitry integrated on a single chip.

The gates of the transistors may be directly connected to the input voltage rails. Assuming a purely resistive load 207, and an ideal switching performance of the transistors, the following conditions are fulfilled:
u₂(t)=|u₁(t)|, if |u₁(t)|≧u_{THR}, and (2a)
u₂(t)=0, if |u₁(t)|<u_{THR}, (2b)
whereby voltage u_{THR} denotes a MOS-threshold voltage, which here is assumed to be equal for both, PMOS and NMOS transistors. For u₁(t)≧u_{THR}, transistors 201 and 202 are switched on (low impedance), whereas transistor 203 and 204 are switched off (high impedance), and vice versa for u₁ (t)≦−u_{THR}, transistors 203 and 204 are switched on, and transistors 201 and 202 are switched off. Thus, for the special case of an ohmic load, the CMOS-bridge of FIG. 2 represents a full-wave rectifier, similar to the diode bridge FIG. 1. Note that here the full input voltage magnitude applies at load 207, and there is no reduction due to diode voltage drops. Typically, MOS threshold voltages are u_{THR}˜0.7V.

For the implementation of bridge FIG. 2, standard CMOS-technology can be used. For example, using N-well technology, the P-silicon substrate material is connected to the negative potential 211, and the N-wells are connected to the positive potential 212 of the output port. In various embodiments, the four transistors may be sufficiently large to ensure a small voltage drop during the switch ON-states. If these voltage drops are too large (typically, larger than about 0.7V), then parasitic substrate PN-diodes get conductive, adversely affecting operation of a chip, for example, that includes both the two port 205 and load 206.

Assuming a sinusoidal input voltage, the CMOS-bridge 205 in FIG. 2 does not fully work as a rectifier for all types of loads. The reason is that transistors operated in ON-states allow current flowing in both directions—in contrast to a diode. For example, if the load 206 is composed of a resistor 208 and a smoothing capacitor 209 in parallel, then the capacitor is partly discharged via transistors in switch-turn-ON states. Assuming u₁(t)>u_{THR}, transistors 201 and 202 are switched on, and in this situation, voltage u₂(t) simply follows the input voltage u₁(t). This means that the capacitor 209 is discharged not only via the resistor 208, but also via the input lines. However, a true rectifier characteristic is obtained again, if a diode 210 is connected in series to resistor 208 and capacitor 209. The advantage as compared to a diode-bridge FIG. 1 is that only one diode voltage drop appears instead of two.

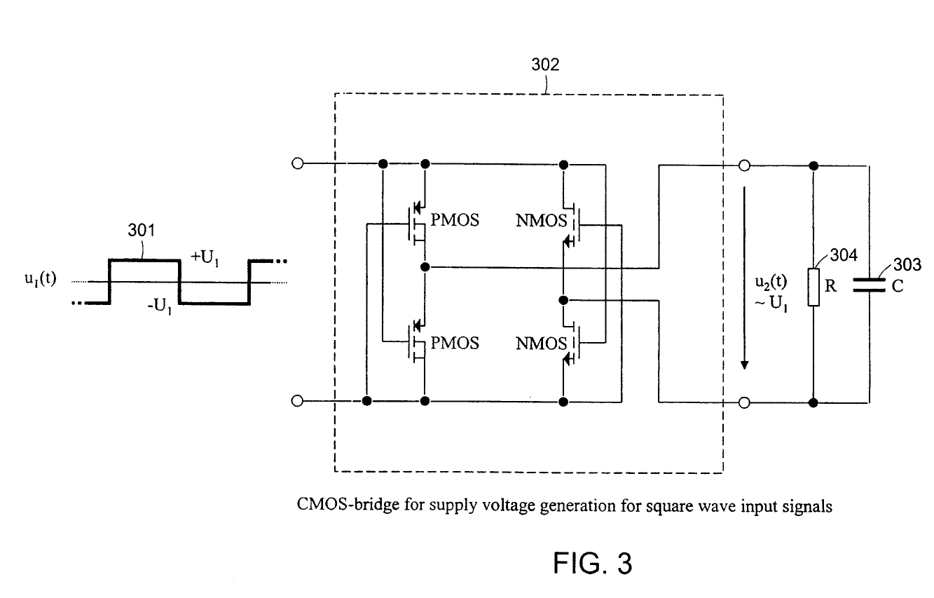

FIG. 3 is a schematic showing a CMOS-bridge 302 for use, without limitation, with square- or rectangular-wave input signals, in accordance with an embodiment of the invention. As shown in FIG. 3, if the input voltage is not a sinusoidal, but a square- or rectangular-wave 301 with two levels ±U₁, then CMOS-bridge 302 can be operated as a full-wave rectifier without an additional diode, even if the load is composed of a resistor 304 and a capacitor 303. In this case the output voltage is u₂(t)˜U₁. Resistor 304 may represent the power consumption of a complex electronic circuit.

While FIG. 3 shows a square wave signal being applied to an embodiment, the input may usefully be a more general rectangular wave signal. In the general case of a rectangular wave input signal, embodiments would not necessarily require a discrete capacitive component such as output capacitor 303, such that the only output capacitance might be relatively small parasitic capacitances from components and leads.

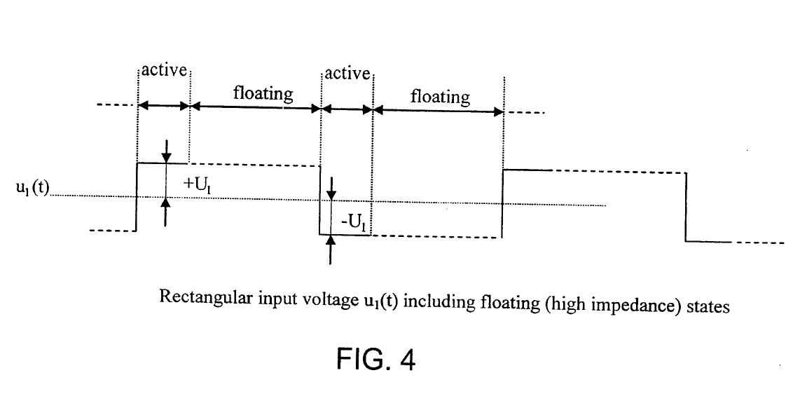

Moreover, for the circuit shown in FIG. 3, when the input terminals have a high impedance across them, as in the case where they are unconnected, the bridge circuit may possesses the interesting property of remaining stable in its existing logic state. For example, as shown in FIG. 4, assume that a +5 vdc input is applied to the input terminals during the time period on the left labeled as “active.” Then, the same +5 vdc will be passed to the output terminals and across output resistor 304 and output capacitor 303. Assuming that the input signal is then disconnected from the input terminals, the PMOS switch in the upper left and the NMOS switch in the lower right of the circuit will remain in a low impedance state, and, assuming the RC time constant of resistor 304 and capacitor 303 are sufficiently large, the put voltage will continue to float at +5 vdc due to capacitor 303. The same thing happens oppositely on the right side of FIG. 4 during the second active and floating periods. This may be a useful property in some situations such as low power applications when it may be possible to apply the input signal for relatively short active periods and let the circuit float during succeeding inactive periods. Such a signal having active and floating periods need not necessarily be periodic, but in some applications may be non-periodic signal such as a data signal.

The CMOS-bridge in the above-described embodiments may advantageously be used in a wide variety of applications. For example, the CMOS-bridge may be used to provide rectification and/or to ensure a desired supply voltage polarity, in diverse fields such as, without limitation, the automotive or medical fields. For example, a chip containing such a CMOS bridge may be part of an implantable medical device such as a retinal implant system or a cochlear implant system. Embodiments may also include using such a circuit as the basis for a polarity protection circuit which allows for arbitrary connecting of the inputs to a dc source, independently of the polarity.

Although various exemplary embodiments of the invention have been disclosed, it should be apparent to those skilled in the art that various changes and modifications can be made which will achieve some of the advantages of the invention without departing from the true scope of the invention.

What is claimed is:

1. A rectifier circuit comprising:
first and second input terminals for receiving a rectangular wave input voltage;
first and second output terminals for providing a rectified dc output voltage;
a first switch coupled between the first input terminal and a first node, the first node coupled to the first output terminal;
a second switch coupled between the second input terminal and the first node;
a third switch coupled between the first input terminal and a second node, the second node coupled to the second output terminal; and
a fourth switch coupled between the second input terminal and to the second node,
wherein the first switch and fourth switch are gated on when the input voltage is of a first polarity; and wherein the second switch and the third switch are gated on when the input voltage is of a second polarity opposite the first polarity so as to provide an output voltage having a magnitude substantially equal to the magnitude of the input voltage.

2. The rectifier circuit according to claim 1, wherein the first switch, the second switch, the third switch, and the fourth switch are MOS transistors.

3. The rectifier circuit according to claim 2, wherein the first switch and the second switch are PMOS transistors, and wherein the third switch and fourth switch are NMOS transistors.

4. The rectifier circuit according to claim 3, wherein the first switch and the fourth switch are gated by one of the first input terminal and the second input terminal, and wherein the second switch and the third switch are gated by the other of the one of the first input terminal and the second input terminal.

5. The rectifier circuit according to claim 1, wherein the output voltage is provided for a parallel load combination of a resistance and a capacitance.

6. The rectifier circuit according to claim 5, wherein the parallel load and the rectifier circuit are integrated on a single chip.

7. The rectifier circuit according to claim 1, wherein the output voltage is provided for a resistive load without a discrete parallel capacitor.

8. The rectifier circuit according to claim 7, wherein the resistive load and the rectifier circuit are integrated on a single chip.

9. A polarity protection circuit comprising the rectifier circuit according to claim 1.

10. An implanted medical device comprising the rectifier circuit of claim 1.

11. An implanted medical device according to claim 1, wherein the medical device is a retinal implant.

12. An implanted medical device according to claim 1, wherein the medical device is a cochlear implant.

13. A chip comprising:
the rectifier circuit according to claim 1; and
a parallel load combination of a resistance and a capacitance coupled between the first and second output terminals.

14. The chip according to claim 13, wherein the load includes a signal processor.

15. A chip comprising:
the rectifier circuit according to claim 1; and
a resistive load coupled between the first and second output terminals without a discrete parallel capacitor.

16. The chip according to claim 15, wherein the load includes a signal processor.

17. A method of rectifying, the method comprising:
applying a rectangular wave input signal between a first input terminal and a second input terminal, a first switch coupled between the first input terminal and a first node, a second switch coupled between the second input terminal and the first node, the first node coupled to a first output terminal, a third switch coupled between the first input terminal and a second node, a fourth switch coupled between the second input terminal and the second node; the second node coupled to a second output terminal;
wherein the first switch and fourth switch are gated on when the input signal is of a first polarity; and wherein the second switch and the third switch are gated on when the input signal is of a second polarity opposite the first polarity so that the first and second output terminals provide a rectified dc voltage having a magnitude substantially equal to the magnitude of the input voltage.

18. The method according to claim 17, wherein the first switch, the second switch, the third switch, and the fourth switch are MOS transistors.

19. The method according to claim 18, wherein the first switch and the second switch are PMOS transistors, and wherein the third switch and fourth switch are NMOS transistors.

20. The method according to claim 19, wherein the first switch and the fourth switch are gated by one of the first input terminal and the second input terminal, and wherein the second switch and the third switch are gated by the other of the one of the first input terminal and the second input terminal.

21. The method according to claim 17, wherein the output voltage is provided for a parallel load combination of a resistance and a capacitance.

22. The method according to claim 17, wherein the output voltage is provided for a resistive load without a discrete parallel capacitor.

23. The method according to claim 17, further comprising:
disconnecting the input signal from the input terminals for a period of time after the switches are gated on.

24. The method according to claim 17, wherein the rectangular wave input signal is non-periodic.
